(19) United States
(12) Patent Application Publication
(10) Pub. No.: US 2019/0045082 A1
(43) Pub. Date: Feb. 7, 2019

(54) IMAGE DATA CREATING DEVICE AND PRINTING SYSTEM INCLUDING THE SAME

(71) Applicant: Roland DG Corporation, Hamamatsu-shi (JP)

(72) Inventor: Norishige KAKUNO, Hamamatsu-shi (JP)

(21) Appl. No.: 16/051,598

(22) Filed: Aug. 1, 2018

(30) Foreign Application Priority Data
Aug. 2, 2017 (JP) 2017-149881

(51) Int. Cl. H04N 1/54; H04N 1/60; H04N 1/23

(52) U.S. Cl. CPC H04N 1/54; H04N 1/233; H04N 1/603

(57) ABSTRACT

An image data creating device includes a converter that converts first image data defined by an input signal value to second image data defined by an output signal value of a CMYK color space, and a changer that changes, in forming a mixed color represented by mixing at least two of a cyan ink, a magenta ink, a yellow ink, and a black ink, based on the second image data, the second image data such that at least a portion of the cyan ink, the magenta ink, the yellow ink, and the black ink is replaced with a first special color ink that has a first special color that is a color other than cyan, magenta, yellow, and black.

### CROSS REFERENCE TO RELATED APPLICATIONS

This application claims the benefit of priority to Japanese Patent Application No. 2017-149881 filed on Aug. 2, 2017. The entire contents of this application are hereby incorporated herein by reference.

### BACKGROUND OF THE INVENTION

### 1. Field of the Invention

The present invention relates to an image data creating device and a printing system including the same.

### 2. Description of the Related Art

Conventionally, inkjet printers which include ink heads that discharge inks to a recording medium have been known. The ink heads include nozzles that discharge the inks. The inks that are discharged from the nozzles are a cyan ink, a magenta ink, a yellow ink, and a black ink of four colors as basic colors and various colors (mixed colors) can be represented by mixing the inks.

Incidentally, a color presented by an input device, such as a digital camera or the like, is represented by a signal value of an RGB color space or a CMYK color space, and also, a color presented by an output device, such as a printer or the like, is represented by a signal value of the CMYK color space. That is, the signal value of the color that is presented by the input device and the signal value of the color presented by the output device are different. Therefore, an image data creating device that converts the signal value of the RGB color space or the like of the input device to the signal value of the CMYK color space of the output device is used. The image data creating device converts the input signal value to a saturation value represented in a profile connection space (PCS). As the PCS, for example, a device-independent space (an L*a*b* color space) is employed. Then, the image data creating device converts the converted saturation value to an output signal value.

Japanese Laid-open Patent Publication No. 2006-31376 describes that an input signal value is converted to a signal value including four basic colors of CMYK for use in printing in an output device, and the converted signal value is further converted to a signal value including the four basic colors of CMYK, light cyan (LC), and light magenta (LM).

In a technology described in Japanese Laid-open Patent Publication No. 2006-31376 above, after an input signal value is converted to an output signal value including the four basic colors of CMYK for use in printing, the converted output signal value is further converted to a signal value including colors, that is, the four basic colors of CMYK and LC and LM added thereto, using a predetermined lookup table (LUT). Therefore, when an ink of a different color (for example, orange, red, green, or the like) from light cyan (LC) or light magenta (LM) is intended to be used, it is necessary to prepare a separate lookup table and then convert a signal value of the ink to a signal value including a color obtained by adding orange or the like to the four basic colors of CMYK. Also, there is a tendency that, as the number of colors that are added increases, a size of data increases and process speed is reduced.

### SUMMARY OF THE INVENTION

In view of the forgoing, preferred embodiments of the present invention provide image data creating devices that are able to easily and simply create image data including the special color ink when an image is printed using the four basic colors of CMYK and a special color ink other than the four basic colors of CMYK.

An image data creating device according to a preferred embodiment of the present invention includes a table memory that stores a first table that indicates a correspondence relation between an input signal value and a saturation value of a device-independent color space, a second table that indicates a correspondence relation between an output signal value of a CMYK color space and the saturation value of the device-independent color space, and a third table that indicates a correspondence relation between a signal value of a first special color that is a color other than cyan, magenta, yellow, and black in the CMYK color space and signal values of cyan, magenta, yellow, and black when the first special color is represented using cyan, magenta, yellow, and black, a converter that converts first image data defined by the input signal value to second image data defined by the output signal value of the CMYK color space using the first table and the second table, and a changer that changes, in forming a mixed color represented by mixing at least two inks of a cyan ink, a magenta ink, a yellow ink, and a black ink, based on the second image data, the second image data such that at least a portion of the cyan ink, the magenta ink, the yellow ink, and the black ink is replaced with a first special color ink that has the first special color using the third table.

In the image data creating device according to this preferred embodiment of the present invention, the table memory stores the third table that indicates the correspondence relation between the signal value of the first special color and the signal values of cyan, magenta, yellow, and black. The changer changes, in forming the mixed color, the second image data such that at least a portion of the cyan ink, the magenta ink, the yellow ink, and the black ink is replaced with the first special ink using the third table. In the above-described manner, when the first special color ink is added to inks of four basic colors of CMYK, it is possible to change a portion of data represented by the four basic colors of CMYK and replace a portion of the cyan ink, the magenta ink, the yellow ink, and the black ink with the first special color ink, and therefore, image data that includes the first special color ink is able to be easily and simply created. Also, by using the first special color ink, a total use amount of ink is able to be reduced as compared to a case in which at least two of inks of the cyan ink, the magenta ink, the yellow ink, and the black ink are mixed to form the first special color. Also, by using the first special color ink, a color reproduction range is able to be expanded and bleeding or condensation of ink, the generation of dark-and-light stripes (banding), or the like is significantly reduced or prevented. Furthermore, it is not necessary to use a table that directly converts an input signal value to a signal value including colors, that is, the four basic colors of CMYK and the first special color added thereto, and therefore, data is able to be reduced and processing speed is able to be increased.

According to this preferred embodiment of the present invention, an image data creating device that is able to easily and simply create image data including the special color when an image is printed using the four basic colors of CMYK and a special color ink other than CMYK.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printing system according to a preferred embodiment of the present invention.

FIG. 2 is a front view of a major portion of an inkjet printer according to a preferred embodiment of the present invention.

FIG. 3 is a block diagram illustrating a configuration of an image data creating device according to a preferred embodiment of the present invention.

FIG. 4 is a flowchart illustrating steps of creating second image data according to a preferred embodiment of the present invention.

### DETAILED DESCRIPTION OF THE PREFERRED EMBODIMENTS

With reference to the attached drawings, image data creating devices according to preferred embodiments of the present invention and printing systems including the same will be described. Note that, as a matter of course, preferred embodiments described herein are not intended to be particularly limiting the present invention. Also, members and portions that have the same function are denoted by the same reference characters and redundant description will be omitted or simplified, as appropriate.

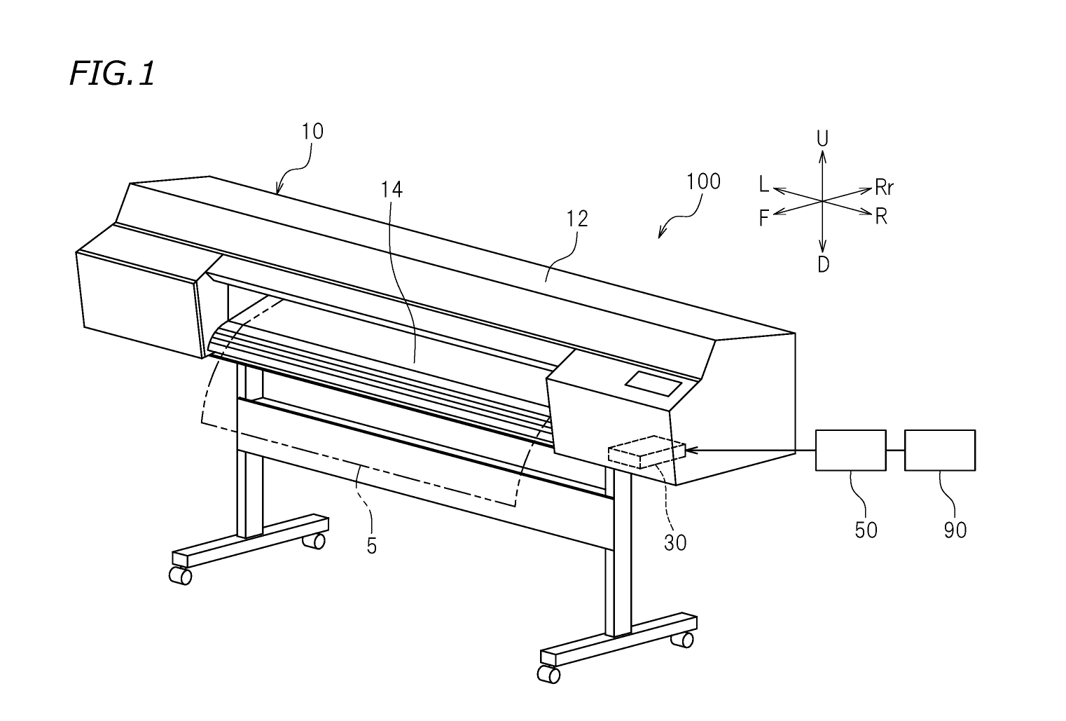

As illustrated in FIG. 1, a printing system 100 includes a printer 10, an image data creating device 50, and a display 90. The display 90 is connected to the image data creating device 50. The display 90 is, for example, a liquid crystal display. Note that the display 90 may be integrated with the image data creating device 50.

The printer 10 is an inkjet printer (which will be hereinafter referred to as a printer) 10 that performs printing on a recording medium 5. Examples of the recording medium 5 include mediums made of various types of materials, such as a resin material, such as polyvinyl chloride (PVC), polyester, or the like, aluminum, iron, wood, or the like, as well as, of course, paper products, such as regular paper.

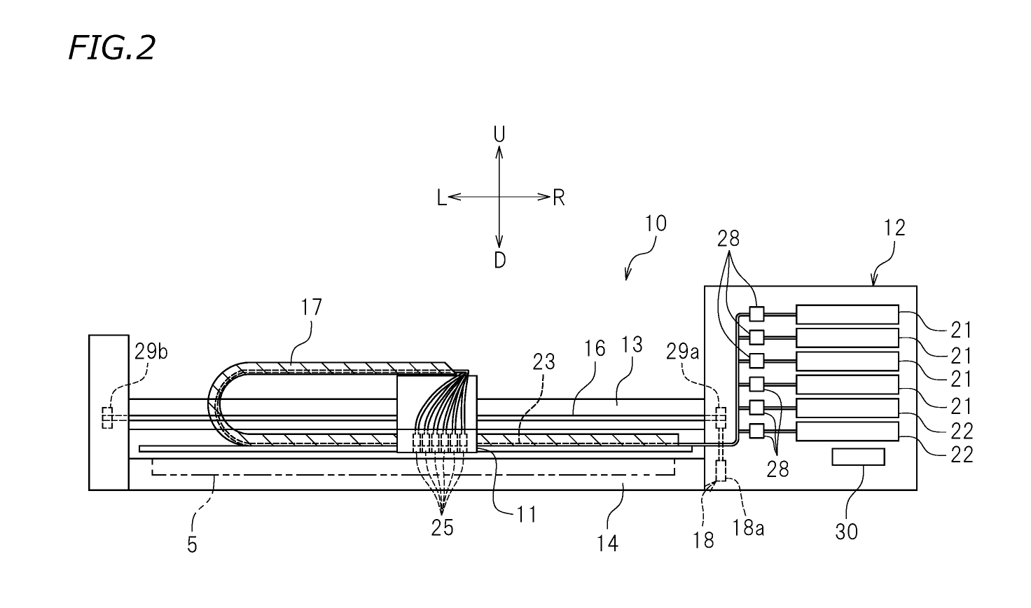

In the following description, left, right, up, and down mean left, right, up, and down when viewed from an operator who is present in front of the printer 10, respectively. Also, it is assumed that a direction approaching the operator from the printer 10 is a forward direction and a direction away from the operator is a rear direction. In the drawings, reference symbols F, Rr, L, R, U, and D indicate front, rear, left, right, up, and down, respectively. An ink head 25 (see FIG. 2), which will be described later, is movable to left and right. The recording medium 5 can be conveyed forward and backward. However, these directions are used herein merely for convenience of description and do not limit setting modes of the printer 10.

As illustrated in FIG. 2, the printer 10 includes a casing 12 and a guide rail 13 disposed in the casing 12. The guide rail 13 extends in a left-and-right direction. A carriage 11 is engaged with the guide rail 13. An ink head 25 that discharges ink is provided in the carriage 11. The carriage 11 is caused to reciprocate along the guide rail 13 in the left-and-right direction (that is, a scanning direction) by a carriage transporter 18. The carriage transporter 18 includes pulleys 29b and 29a arranged in a left end side and a right end side of the guide rail 13, respectively. A carriage motor 18a is linked to the pulley 29a. Note that the carriage motor 18a may be linked to the pulley 29b. The pulley 29a is driven by the carriage motor 18a. An endless belt 16 is wound on each of the pulleys 29a and 29b. The carriage 11 is fixed to the belt 16. When the pulleys 29a and 29b rotate and thus the belt 16 runs, the carriage 11 moves in the left-and-right direction.

The recording medium 5 is conveyed by a paper feeding mechanism (not illustrated) in a paper feeding direction. In this case, the paper feeding direction is a front-and-rear direction. A platen 14 on which the recording medium 5 is placed is provided in the casing 12. A grit roller (not illustrated) is provided to the platen 14. A pinch roller (not illustrated) is provided above the grit roller. The grit roller is linked to a feed motor (not illustrated). The grit roller is driven by the feed motor and rotates. When the grit roller rotates with the recording medium 5 interposed between the grit roller and the pinch roller, the recording medium 5 is conveyed in the front-and-rear direction.

As illustrated in FIG. 2, the printer 10 includes a plurality of ink cartridges 21 and 22. Inks of different colors are provided in the plurality of ink cartridges 21 and 22. Each of a cyan ink, a magenta ink, a yellow ink, and a black ink is provided in a corresponding one of the ink cartridges 21. Each of an orange ink and a red ink as special color inks is provided in a corresponding one of the ink cartridges 22. Note that the inks provided in the ink cartridges 22 are not limited to the orange ink and the red ink but may be a green ink, a violet ink, or the like. Also, the printer 10 includes two ink cartridges 22 but may include one ink cartridge 22 or three or more ink cartridges 22.

The ink head 25 is provided for each ink of each color. The ink head 25 of each color is connected to a corresponding one of the ink cartridges 21 and 22 via an ink supply channel 23. The ink supply channel 23 is an ink flow channel through which inks are supplied from the ink cartridges 21 and 22 to the ink heads 25. The ink supply channel 23 is formed of, for example, a tube having flexibility. A liquid feeding pump 28 is provided in the ink supply channel 23. However, the liquid feeding pump 28 is not necessarily needed and may be omitted. A portion of the ink supply channel 23 is covered by a cable protecting guide 17.

The printer 10 includes a controller 30 provided in the printer 10. The controller 30 is connected to the carriage motor 18a of the carriage transporter 18, the feed motor of the paper feeding mechanism, the liquid feeding pump 28, and the ink heads so as to be communicable therewith. The controller 30 is configured or programmed to control operations of these elements. Typically, the controller 30 is a computer. The controller 30 includes, for example, an interface (I/F) that receives print data or the like from an external device, such as a host computer or the like, a central processing unit (CPU) that executes an instruction of a control program, a ROM that stores a program(s) that is executed by the CPU, a RAM that is used as a working area in which the program is developed, and a storage, such as a memory or the like, which stores the above-described program(s) or various types of data.

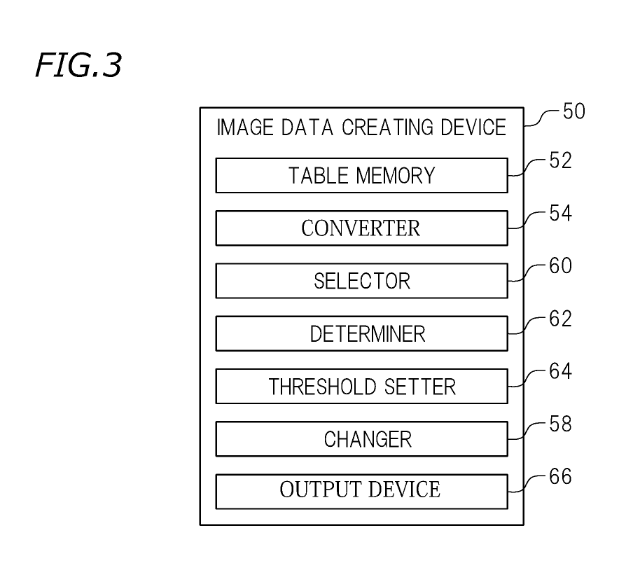

Next, the image data creating device 50 according to this preferred embodiment will be described. As illustrated in FIG. 1, the image data creating device 50 is an external device that is connected to the printer 10. However, the image data creating device 50 may be mounted in the printer 10. The image data creating device 50 preferably is a computer that includes a CPU, a ROM, a RAM, or the like. As illustrated in FIG. 3, the image data creating device 50 is configured or programmed to include a table memory 52, a converter 54, a changer 58, a selector 60, a determiner 62, a threshold setter 64, and an output device 66. Each of these components preferably is realized by a program or programs. The program(s) is read from a recording medium, such as, for example, a CD, a DVD, or the like. Note that the program(s) may be downloaded via the Internet. Also, each of the above-identified elements of the image data creating device 50 may be realizable by a processor, a circuit, and/or the like. Note that specific control or the like of each of the above-described components will be described later.

The table memory 52 stores a first table that indicates a correspondence relation between an input signal value and a saturation value of a device-independent color space and a second table that indicates a correspondence relation between an output signal value of a CMYK color space and a saturation value of the device-independent color space. The first table and the second table are, for example, ICC profiles. In this case, as the input signal value in this preferred embodiment, for example, a signal value of the RGB color space in the input device and a signal value of the CMYK color space in the input device are used, for example. As the input device, for example, a digital camera is used, for example. The output device of this preferred embodiment is the printer 10, for example. The device-independent color space of this preferred embodiment is an L*a*b* color space, for example.

The table memory 52 stores a third table that indicates a correspondence relation between a signal value of a first special color that is a color other than cyan (C), magenta (M), yellow (Y), and black (K) in the CMYK color space and signal values of cyan, magenta, yellow, and black when the first special color is represented using cyan, magenta, yellow, and black. In this case, the first special color is a color other than cyan (C), magenta (M), yellow (Y), and black (K). That is, the first special color is a color other than the four basic colors of CMYK. The first special color can be a mixed color represented by mixing at least two inks of cyan (C), magenta (M), yellow (Y), and black (K). As the first special color, for example, red (R), orange (O), green (G), violet (V), or the like is used.

Furthermore, the table memory 52 stores a fourth table that indicates a correspondence relation between a signal value of a second special color that is a color other than cyan (C), magenta (M), yellow (Y), and black (K) in the CMYK space and the first special color and signal values of cyan (C), magenta (M), yellow (Y), and black (K) when the second special color is represented using cyan (C), magenta (M), yellow (Y), and black (K). In this case, the second special color is a color other than cyan (C), magenta (M), yellow (Y), black (K), and the first special color. That is, the second special color is a color other than the four basic colors of CMYK and the first special color. The second special color can be a mixed color represented by mixing at least two inks of cyan (C), magenta (M), yellow (Y), and black (K). As the second special color, similar to the first special color, for example, red (R), orange (O), green (G), violet (V), or the like is employed. The table memory 52 stores the above-described tables in accordance with types of the special color inks that are provided in the ink cartridges 22 (see FIG. 2) mounted in the printer 10.

The converter 54 converts first image data defined by the input signal value to second image data defined by the output signal value of the CMYK color space using the first table and the second table stored in the table memory 52. The first image data is transmitted to the image data creating device 50, for example, from an external device, such as a host computer or the like, or a network connected thereto via a wired or wireless connection.

The selector 60 is configured or programmed to receive, for example, an operation of a user and perform selection, which will be described later. For example, the user operates a button that is displayed on the display 90 connected to the image data creating device 50, and as a result, a signal is transmitted to the selector 60. The selector 60 receives the signal and selects a first option or a second option. The first option is to use the cyan ink, the magenta ink, the yellow ink, the black ink, and the first special color ink (or the second special color ink) in forming the mixed color, based on the second image data. The second option is to use the first special color ink and the second special color ink in forming the mixed color, based on the second image data. Note that, in the second option, it is not necessary to use the cyan ink, the magenta ink, the yellow ink, and the black ink. Note that the selector 60 is able to select the first option or the second option for each mixed color. Also, the selector 60 may be configured or programmed to be able to select a third option of using only the cyan ink, the magenta ink, the yellow ink, and the black ink in forming the mixed color, based on the second image data.

The determiner 62 determines, in forming the mixed color, whether or not a first ratio of a total ink amount of two or more types (for example, two types or three types) of the cyan ink, the magenta ink, the yellow ink, and the black ink which are replaceable with the first special color ink to a total ink amount of all of the cyan ink, the magenta ink, the yellow ink, and the black ink is a predetermined first threshold or more. The determiner 62 determines, in forming the mixed color, whether or not a second ratio of a total ink amount of two or more types (for example, two types or three types) of the cyan ink, the magenta ink, the yellow ink, and the black ink which are replaceable with the second special color ink to the total ink amount of all of the cyan ink, the magenta ink, the yellow ink, and the black ink is a predetermined second threshold or more. For example, if the first special color (or the second special color) is red, the determiner 62 determines whether or not the first ratio of the total ink amount of the magenta ink, the yellow ink, and the black ink to the total ink amount of all of the magenta ink, the yellow ink, the cyan ink, and the black ink is the first threshold (or whether or not the second ratio is the second threshold) or more. The determiner 62 is configured or programmed to perform the above-described determination for each pixel.

The threshold setter 64 is configured or programmed to receive, for example, an operation of the user and set the first threshold and the second threshold. For example, the user operates a button that is displayed on the display 90, and as a result, a signal is transmitted to the threshold setter 64. The threshold setter 64 receives the signal and sets the first threshold and/or the second threshold. Each of the first threshold and the second threshold is set to, for example, about 0.8 to about 1. Note that each of the first threshold and the second threshold can be set to an arbitrary value by the user.

The changer 58 changes, in forming a mixed color that is represented by mixing at least two inks of the cyan ink, the magenta ink, the yellow ink, and the black ink, based on the converted second image data, the second image data such that at least a portion of the cyan ink, the magenta ink, the yellow ink, and the black ink is replaced with the first special color ink that has the first special color using the third table. Also, the changer 58 may be configured or programmed to change, in forming the mixed color, the second image data such that all of the cyan ink, the magenta ink, the yellow ink, and the black ink are replaced with the first special color using the third table. For example, if a color of one pixel is red, normally, the magenta ink and the yellow ink are mixed to form red, but the changer 58 may be configured or programmed to change the second image data such that, instead of forming red using the magenta ink and the yellow ink, red is directly formed using a red ink as the first special color. Note that, in a case in which a portion or all of the cyan ink, the magenta ink, the yellow ink, and the black ink are replaced with the second special color ink, the fourth table is used. Note that the changer 58 is configured or programmed to use, if there are not the signal values of the first special color and the second special color that are used in forming the mixed color in the third table and the fourth table, closest values thereto.

The changer 58 may be configured or programmed to change, if the first option has been selected by the selector 60, the second image data such that at least a portion of the cyan ink, the magenta ink, the yellow ink, and the black ink is replaced with the first special color ink using the third table. The changer 58 may be configured or programmed to change, if the first option has been selected by the selector 60, the second image data such that at least a portion of the cyan ink, the magenta ink, the yellow ink, and the black ink is replaced with the second special color ink using the fourth table.

The changer 58 may be configured or programmed to change, if it has been determined by the determiner 62 that the first ratio is the first threshold or more, the second image data such that at least two types of the cyan ink, the magenta ink, the yellow ink, and the black ink are replaced with the first special color ink and not to change, if it has been determined by the determiner 62 that the first ratio is less than the first threshold, the second image data. Also, the changer 58 may be configured or programmed to change, if it has been determined by the determiner 62 that the second ratio is the second threshold or more, the second image data such that at least two types of the cyan ink, the magenta ink, the yellow ink, and the black ink are replaced with the second special color ink and not to change, if it has been determined by the determiner 62 that the second ratio is less than the second threshold, the second image data.

The changer 58 may be configured or programmed to change, in forming the mixed color, based on the converted second image data, the second image data such that at least a portion of the cyan ink, the magenta ink, the yellow ink, and the black ink is replaced with the first special color ink and the second special color ink using the third table and the fourth table. Also, the changer 58 may be configured or programmed to change, in forming the mixed color, the second image data such that all of the cyan ink, the magenta ink, the yellow ink, and the black ink are replaced with the first special color ink and the second special color ink using the third table and the fourth table. For example, the changer 58 may be configured or programmed to change, if a color of one pixel is an intermediate color between red and orange, the second image data such that the intermediate color is formed using a red ink as the first special color ink and an orange ink as the second special color ink, instead of forming red and orange using the magenta ink, the yellow ink, and the black ink.

The changer 58 may be configured or programmed to change, if the second option has been selected by the selector 60, the second image data such that at least a portion of the cyan ink, the magenta ink, the yellow ink, and the black ink is replaced with the first special color ink and the second special color ink using the third table and the fourth table. The changer 58 may be configured or programmed to change, if it has been determined by the determiner 62 that the first ratio is the first threshold or more and the second ratio is the second threshold or more, the second image data such that all of the cyan ink, the magenta ink, the yellow ink, and the black ink are replaced with the first special color ink and the second special color ink.

The output device 66 transmits the second image data that has been changed by the changer 58 to the controller 30 of the printer 10. Note that, based on determination made by the determiner 62, if the second image data has not been changed at all, the second image data that has been converted by the converter 54 is transmitted to the controller 30 of the printer 10. In the printer 10, based on the received second image data, the controller 30 controls the ink heads 25 or the like to perform printing on the recording medium 5.

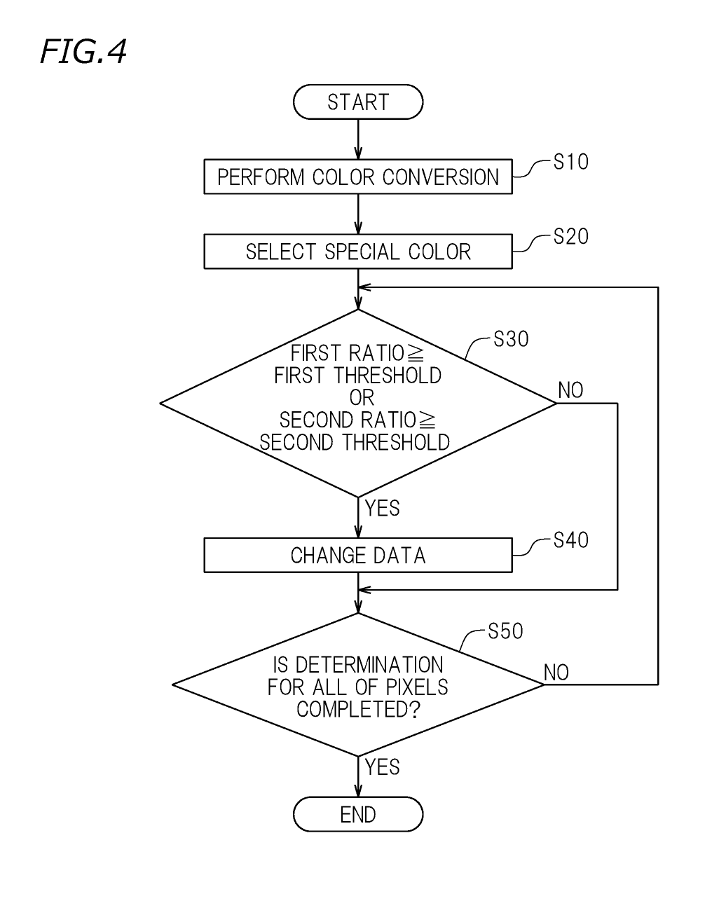

FIG. 4 is a flowchart illustrating steps of creating the second image data. The steps of creating the second image data will be described below.

First, in Step S10, color conversion of first image data that has been transmitted from an external device, such as a host computer or the like, to the image data creating device 50 is executed. Specifically, the converter 54 converts first image data defined by an input signal value to second image data defined by an output signal value of the CMYK color space using the first table and the second table stored in the table memory 52.

In Step S20, the user operates a button that is displayed on the display 90 connected to the image data creating device 50 to select the first option or the second option. Thus, the selector 60 selects the first option or the second option.

In Step S30, the determiner 62 determines, based on the first option or the second option, which has been selected by the selector 60, whether or not the first ratio is the first threshold or more or whether or not the second ratio is the second threshold or more for each pixel. If it has been determined that the first ratio is the first threshold or more or that the second ratio is the second threshold or more, the process proceeds to Step S40. On the other hand, based on the first option or the second option, which has been selected by the selector 60, if it has been determined that the first ratio is less than the first threshold or that the second ratio is less than the second threshold, the changer 58 does not change the second image data and the process proceeds to Step S50. For example, if the first option has been selected by the selector 60, the determiner 62 determines whether or not the first ratio is the first threshold or more. Then, if the first ratio is the first threshold or more, the process proceeds to Step S40 and, if the first ratio is less than the first threshold, the process proceeds to Step S50.

In Step S40, if the first option has been selected in Step S20, the changer 58 changes the second image data such that at least a portion of the cyan ink, the magenta ink, the yellow ink, and the black ink is replaced with the first special color ink using the third table. Also, if the second option has been selected in Step S20, the changer 58 changes the second image data such that at least a portion of the cyan ink, the magenta ink, the yellow ink, and the black ink is replaced with the first special color ink and the second special color ink using the third table and the fourth table. For example, if a mixed color that is to be formed cannot be represented only by the first special color, a portion of the four basic colors of the cyan ink, the magenta ink, the yellow ink, and the black ink is replaced with the first special color ink and, if a mixed color that is to be formed can be represented only by the first special color, all of the four basic colors are replaced with the first special color ink.

In Step S50, the image data creating device 50 determines, by the determiner 62, whether or not determination for all of pixels of the second image data is completed. If determination for all of pixels is completed, processing of creating the second image data is terminated. On the other hand, if determination for all of pixels is not completed, the process returns to Step S30 and determination for a next pixel is performed.

As described above, in the image data creating device 50 of this preferred embodiment, the table memory 52 stores the third table that indicates a correspondence relation between the signal value of the first special color and the signal values of cyan, magenta, yellow, and black. In forming a mixed color, the changer 58 changes the second image data such that at least a portion of the cyan ink, the magenta ink, the yellow ink, and the black ink is replaced with the first special color ink using the third table. In the above-described manner, when the first special color ink is added to the four basic colors of CMYK, a portion of data represented by the four basic colors of CMYK can be changed and a portion of the cyan ink, the magenta ink, the yellow ink, and the black ink can be replaced with the first special color ink, and therefore, image data including the first special color ink is able to be easily and simply created. Also, by using the first special color ink, the total use amount of ink can be reduced as compared to a case in which at least two types of inks of the cyan ink, the magenta ink, the yellow ink, and the black ink are mixed to form the first special color. Also, by using the first special color ink, a color reproduction range is able to be expanded and bleeding or condensation of ink, the generation of dark-and-light stripes (banding), or the like is able to be significantly reduced or prevented. Furthermore, it is not necessary to use a table that directly converts an input signal value to a signal value including colors, that is, the four basic colors of CMYK and the first special color added thereto, and therefore, data is reduced and processing speed is able to be increased.

In the image data creating device 50 of this preferred embodiment, the changer 58 may be configured or programmed to change, in forming a mixed color represented by mixing at least two inks of the cyan ink, the magenta ink, the yellow ink, and the black ink, based on the second image data, the second image data such that all of the cyan ink, the magenta ink, the yellow ink, and the black ink are replaced with the first special color ink using the third table. Thus, the total use amount of ink is further reduced.

In the image data creating device 50 of this preferred embodiment, the changer 58 changes the second image data such that at least a portion of the cyan ink, the magenta ink, the yellow ink, and the black ink is replaced with the first special color ink and the second special color ink using the third table and the fourth table. Thus, there are cases in which the total use amount of ink is able to be reduced, as compared to a case in which the cyan ink, the magenta ink, the yellow ink, and the black ink are mixed to form a mixed color. Also, it is not necessary to convert the input signal value to the signal value including the four basic colors of CMYK as well as the first special color and the second special color added thereto. That is, data is reduced and processing speed is increased.

In the image data creating device 50 of this preferred embodiment, the changer 58 may be configured or programmed to change the second image data such that all of the cyan ink, the magenta ink, the yellow ink, and the black ink are replaced with the first special color ink and the second special color ink using the third table and the fourth table. Thus, there are cases in which the total use amount of ink is able to be further reduced.

In the image data creating device 50 of this preferred embodiment, the selector 60 selects the first option of using the cyan ink, the magenta ink, the yellow ink, the black ink, and the first special color ink or the second option of using the first special color ink and the second special color ink. Thus, in forming a mixed color, it is possible to arbitrarily select which ink is used.

In the image data creating device 50 of this preferred embodiment, the determiner 62 determines whether or not the first ratio of the total ink amount of two or more types of the cyan ink, the magenta ink, the yellow ink, and the black ink that are replaceable with the first special color ink to the total ink amount of all of the cyan ink, the magenta ink, the yellow ink, and the black ink is the predetermined first threshold or more. Then, if it has been determined that the first ratio is the first threshold or more, the changer 58 changes the second image data such that at least two types of the cyan ink, the magenta ink, the yellow ink, and the black ink are replaced with the first special color ink. Also, if it has been determined that the first ratio is less than the first threshold, the changer 58 does not change the second image data. A printed matter with higher quality is able to be obtained, for example, by setting, as the first threshold, a value with which a color shade (a saturation or the like) is increased to be higher when the first special color ink is used.

The image data creating device 50 of this preferred embodiment includes the threshold setter 64 that sets the first threshold. Thus, a condition for replacement with the first special color ink is able to be arbitrarily set and the degree of freedom of inks that are to be used is able to be increased.

Preferred embodiments of the present invention have been described above. However, the above-described preferred embodiments are merely examples and the present invention may be implemented in various other forms.

Although, in the above-described preferred embodiments, two types of special color inks, that is, the first special color ink that has the first special color and the second special color ink that has the second special color are used, for example, one type of a special color ink may be used and also three or more types of special color inks may be used.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on the invention. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image data creating device comprising:
a table memory that stores a first table that indicates a correspondence relation between an input signal value and a saturation value of a device-independent color space, a second table that indicates a correspondence relation between an output signal value of a CMYK color space and the saturation value of the device-independent color space, and a third table that indicates a correspondence relation between a signal value of a first special color that is a color other than cyan, magenta, yellow, and black in the CMYK color space and signal values of cyan, magenta, yellow, and black when the first special color is represented using cyan, magenta, yellow, and black;
a converter that converts first image data defined by the input signal value to second image data defined by the output signal value of the CMYK color space using the first table and the second table; and
a changer that changes, in forming a mixed color represented by mixing at least two inks of a cyan ink, a magenta ink, a yellow ink, and a black ink, based on the second image data, the second image data such that at least a portion of the cyan ink, the magenta ink, the yellow ink, and the black ink is replaced with a first special color ink that has the first special color using the third table.

2. The image data creating device according to claim 1, wherein the changer changes, in forming the mixed color represented by mixing at least two inks of the cyan ink, the magenta ink, the yellow ink, and the black ink, based on the second image data, the second image data such that all of the cyan ink, the magenta ink, the yellow ink, and the black ink are replaced with the first special color ink using the third table.

3. The image data creating device according to claim 1, wherein
the table memory stores a fourth table that indicates a correspondence relation between a signal value of a second special color that is a color other than cyan, magenta, yellow, and black in the CMYK space and the first special color and signal values of cyan, magenta, yellow, and black when the second special color is represented using cyan, magenta, yellow, and black; and
the changer changes, in forming the mixed color, based on the second image data, the second image data such that at least a portion of the cyan ink, the magenta ink, the yellow ink, and the black ink is replaced with the first special color ink and a second special color ink that has the second special color using the third table and the fourth table.

4. The image data creating device according to claim 3, wherein the changer changes, in forming the mixed color, based on the second image data, the second image data such that all of the cyan ink, the magenta ink, the yellow ink, and the black ink are replaced with the first special color ink and the second special color ink using the third table and the fourth table.

5. The image data creating device according to claim 1, wherein
the table memory stores a fourth table that indicates a correspondence relation between a signal value of a second special color that is a color other than cyan, magenta, yellow, and black in the CMYK space and the first special color and signal values of cyan, magenta, yellow, and black when the second special color is represented using cyan, magenta, yellow, and black;
the image data creating device further includes a selector that selects, in forming the mixed color, based on the second image data, a first option of using the cyan ink, the magenta ink, the yellow ink, the black ink, and the first special color ink or a second option of using the first special color ink and a second special color ink that has the second special color; and
the changer changes, if the first option has been selected, the second image data such that at least a portion of the cyan ink, the magenta ink, the yellow ink, and the black ink is replaced with the first special color ink using the third table and changes, if the second option has been selected, the second image data such that at least a portion of the cyan ink, the magenta ink, the yellow ink, and the black ink is replaced with the first special color ink and the second special color ink using the third table and the fourth table.

6. The image data creating device according to claim 1, further comprising:
a determiner that determines, in forming the mixed color, whether or not a ratio of a total ink amount of two or more of the cyan ink, the magenta ink, the yellow ink and the black ink that are replaceable with the first special color ink to a total ink amount of all of the cyan ink, the magenta ink, the yellow ink, and the black ink is a predetermined threshold or more; wherein
if it has been determined by the determiner that the ratio is the threshold or more, the changer changes the second image data such that at least two of the cyan ink, the magenta ink, the yellow ink, and the black ink are replaced with the first special color ink; and
if it has been determined by the determiner that the ratio is less than the threshold, the changer does not change the second image data.

7. The image data creating device according to claim 6, further comprising:
a threshold setter that sets the threshold.

8. A printing system comprising:
the image data creating device according to claim 1; and
an inkjet printer including an ink head that discharges an ink and performs printing using the second image data generated by the image data creating device.
